(19) United States
(12) Patent Application Publication
(10) Pub. No.: US 2025/0282350 A1
(43) Pub. Date: Sep. 11, 2025

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Daichi Inoue, Tokyo (JP)

(21) Appl. No.: 19/059,728

(22) Filed: Feb. 21, 2025

(30) Foreign Application Priority Data
Mar. 8, 2024 (JP) 2024-035565

(51) Int. Cl. B60W 30/12; B60W 10/20; B60W 30/14; G06V 20/56; G06V 20/58

(52) U.S. Cl. CPC B60W 30/12; B60W 10/20; B60W 30/143; G06V 20/582; G06V 20/588; B60W 2420/403; B60W 2552/15; B60W 2552/53; B60W 2555/60; B60W 2556/10; B60W 2556/20; B60W 2556/40

(57) ABSTRACT

A vehicle control device of an embodiment includes a first recognizer recognizing a first demarcation line and a different vehicle present around a host vehicle based on detection device, a second recognizer recognizing a second demarcation line demarcating a lane around the host vehicle from map, and a judger judging whether or not the first demarcation line and the second demarcation line match each other. When a plurality of first demarcation lines on one side of the first demarcation lines present on the left and right sides of the host vehicle are recognized, a first one side first demarcation line included in the plurality of recognized one side first demarcation lines and the second demarcation line match each other, and predetermined conditions are satisfied, the judger reduces a reliability of matching information between the first one side first demarcation line and the second demarcation line which have matched each other.

### CROSS-REFERENCE TO RELATED APPLICATION

Priority is claimed on Japanese Patent Application No. 2024-035565, filed Mar. 8, 2024, the content of which is incorporated herein by reference.

### BACKGROUND

### Field of the Invention

The present invention relates to a vehicle control device, a vehicle control method, and a storage medium.

### Description of Related Art

In recent years, efforts to provide access to sustainable transportation systems taking vulnerable people among traffic participants into account have become active. In order to realize this, the efforts are focused on research and development for further improvement in traffic safety and convenience through research and development related to autonomous driving technology. In this regard, in the related art, technology of judging whether or not a road sign recognized through image recognition processing and a road sign in map information are consistent with each other and adjusting a reliability of the map information on the basis of judgment results is known (for example, Japanese Unexamined Patent Application, First Publication No. 2019-212188).

### SUMMARY

Incidentally, in autonomous driving technology in the related art, even when a camera demarcation line obtained from a captured camera image and a map demarcation line obtained from map information match each other, this does not necessarily mean that they are highly reliable. For example, when road construction or the like is carried out, avoidance demarcation lines are temporarily drawn on the road to allow vehicles to travel while avoiding the construction site. However, the temporarily drawn demarcation lines may remain during construction or after construction. In such a case, even if the camera demarcation line and the map demarcation line are consistent with each other, there is a probability that the demarcation lines may not be correct. In this manner, there was a problem that, depending on the surrounding situation, there was a probability of misjudgment with respect to demarcation lines.

In order resolve the foregoing problems, this application aims to provide a vehicle control device, a vehicle control method, and a storage medium capable of curbing misjudgment with respect to demarcation lines on the basis of a surrounding situation of a host vehicle. Further, this will ultimately contribute to development of sustainable transportation systems.

The vehicle control device, the vehicle control method, and the storage medium according to this invention employ the following constitutions.
(1): A vehicle control device according to an aspect of this invention is a vehicle control device including a first recognizer recognizing a surrounding situation including a first demarcation line demarcating a traveling lane of a host vehicle and a different vehicle present around the host vehicle on the basis of an output of a detection device detecting the surrounding situation of the host vehicle, a second recognizer recognizing a second demarcation line demarcating a lane around the host vehicle from map information on the basis of positional information of the host vehicle, and a judger judging whether or not the first demarcation line and the second demarcation line match each other. When a plurality of first demarcation lines on one side of the first demarcation lines present on the left and right sides of the host vehicle are recognized by the first recognizer, a first one side first demarcation line included in the plurality of recognized one side first demarcation lines and the second demarcation line match each other, and predetermined conditions are satisfied, the judger reduces a reliability of matching information between the first one side first demarcation line and the second demarcation line which have matched each other.
(2): According to the aspect of the foregoing (1), the predetermined conditions include that the different vehicle passes over the first one side first demarcation line which has been judged to match the second demarcation line.
(3): According to the aspect of the foregoing (1), the vehicle control device further includes a driving controller executing driving control by controlling one of or both a steering and a speed of the host vehicle on the basis of judgment results of the judger. When a second one side first demarcation line which has been judged not to match the second demarcation line by the judger is present among the plurality of one side first demarcation lines recognized by the first recognizer, the driving controller controls traveling of the host vehicle on the basis of the second one side first demarcation line.
(4): According to the aspect of the foregoing (1), the predetermined conditions include that the host vehicle is traveling within a predetermined distance range nearer than a spot under construction or a spot where construction has been carried out in the past.
(5): According to the aspect of the foregoing (1), the predetermined conditions include that a road physical boundary is present in a proceeding direction of the host vehicle.
(6): According to the aspect of the foregoing (1), the vehicle control device further includes a driving controller executing driving control by controlling one of or both a steering and a speed of the host vehicle on the basis of judgment results of the judger. When a road physical boundary extending in a direction different from directions of the first one side first demarcation line and the second demarcation line which have matched each other is present, the driving controller causes the host vehicle to travel along the road physical boundary.
(7): According to the aspect of the foregoing (3), when the second one side first demarcation line extends along the road physical boundary, the judger judges that the second one side first demarcation line is a correct demarcation line. The driving controller causes the host vehicle to travel along the second one side first demarcation line.
(8): According to the aspect of the foregoing (7), the driving controller adjusts a position of the second one side first demarcation line in a direction in which the road physical boundary extends, and causes the host vehicle to travel along the adjusted position of the second one side first demarcation line.
(9): According to the aspect of the foregoing (8), when a distance between the road physical boundary and the second one side first demarcation line is shorter than a predetermined distance, the driving controller adjusts the position of the second one side first demarcation line.
(10): According to the aspect of the foregoing (6), when the host vehicle is traveling in a lane having a gradient equal to or larger than a predetermined value, the driving controller does not execute driving control based on the road physical boundary.
(11): According to the aspect of the foregoing (6), when sign information indicating a construction site is present in a proceeding direction of the host vehicle, the driving controller causes the host vehicle to travel along the road physical boundary.
(12): A vehicle control method according to another aspect of this invention is a vehicle control method in which a computer recognizes a surrounding situation including a first demarcation line demarcating a traveling lane of a host vehicle and a different vehicle present around the host vehicle on the basis of an output of a detection device detecting the surrounding situation of the host vehicle, recognizes a second demarcation line demarcating a lane around the host vehicle from map information on the basis of positional information of the host vehicle, and judges whether or not the first demarcation line and the second demarcation line match each other. When a plurality of first demarcation lines on one side of the first demarcation lines present on the left and right sides of the host vehicle are recognized, a first one side first demarcation line included in the plurality of recognized one side first demarcation lines and the second demarcation line match each other, and predetermined conditions are satisfied, a reliability of matching information between the first one side first demarcation line and the second demarcation line which have matched each other is reduced.
(13): A storage medium according to another aspect of this invention is a computer readable non-transitory storage medium storing a program for causing a computer to recognize a surrounding situation including a first demarcation line demarcating a traveling lane of a host vehicle and a different vehicle present around the host vehicle on the basis of an output of a detection device detecting the surrounding situation of the host vehicle, recognize a second demarcation line demarcating a lane around the host vehicle from map information on the basis of positional information of the host vehicle, and judge whether or not the first demarcation line and the second demarcation line match each other. When a plurality of first demarcation lines on one side of the first demarcation lines present on the left and right sides of the host vehicle are recognized, a first one side first demarcation line included in the plurality of recognized one side first demarcation lines and the second demarcation line match each other, and predetermined conditions are satisfied, a reliability of matching information between the first one side first demarcation line and the second demarcation line which have matched each other is reduced.

According to the aspects of the foregoing (1) to (13), it is possible to curb misjudgment with respect to demarcation lines on the basis of a surrounding situation of a host vehicle.

### BRIEF DESCRIPTION OF THE DRAWINGS

FIG. 1 is a view of a constitution of a vehicle system including a vehicle control device according to an embodiment.

FIG. 2 is a view of functional constitutions of a first controller and a second controller.

FIG. 3 is an explanatory view of judgment processing and driving control in a first scene.

FIG. 4 is an explanatory view of judgment processing and driving control in a second scene.

FIG. 5 is an explanatory view of judgment processing and driving control in a third scene.

FIG. 6 is a flowchart showing an example of processing executed by an autonomous driving control device of the embodiment.

### DESCRIPTION OF EMBODIMENTS

Hereinafter, with reference to the drawings, an embodiment of a vehicle control device, a vehicle control method, and a storage medium of the present invention will be described. Hereinafter, as an example, an embodiment in which a host vehicle is applied as an autonomously driven vehicle including a vehicle control device will be described. Autonomous driving denotes that, for example, driving control is executed by autonomously controlling one of or both a steering and a speed of a vehicle. For example, the driving control described above may include driving control such as an adaptive cruise control (ACC) system, a traffic jam pilot (TJP), a lane keeping assistance system (LKAS), an automated lane change (ALC), and a collision mitigation brake system (CMBS). In an autonomously driven vehicle, driving control may be executed by a manual operation (so-called manual driving) of a user of the vehicle (for example, an occupant). Hereinafter, a case in which the rule of “keep left” is applied will be described. However, in the case in which the rule of “keep right” is applied, the left and right may be reversed.

### [Overall Constitution]

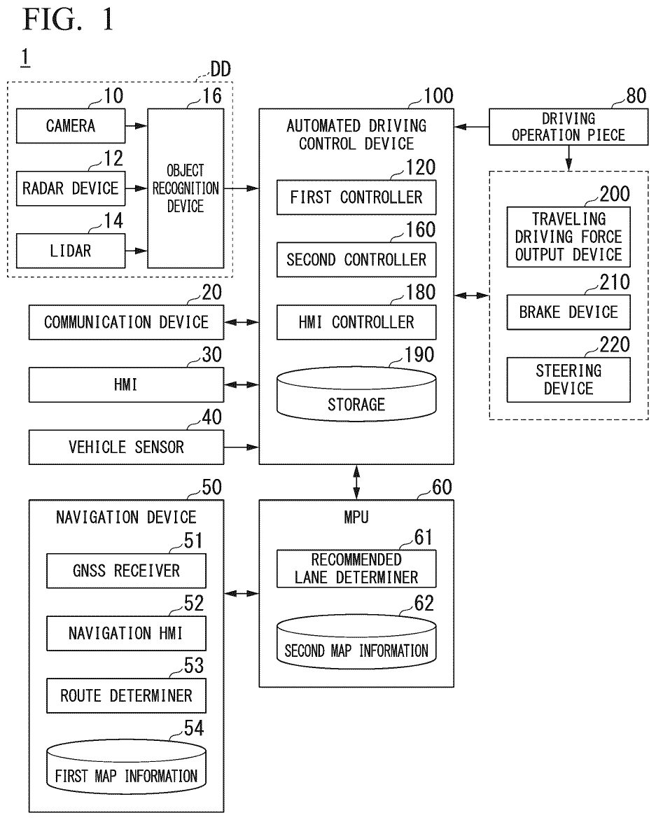

FIG. 1 is a view of a constitution of a vehicle system 1 including a vehicle control device according to the embodiment. A vehicle in which the vehicle system 1 is mounted (which will hereinafter be referred to as a host vehicle M) is a vehicle, for example, having two wheels, three wheels, four wheels, or the like, and a drive source thereof is an internal-combustion engine such as a diesel engine or a gasoline engine, an electric motor, or a combination of these. An electric motor is operated using power generated by a generator connected to an internal-combustion engine, or discharge power of a battery (storage battery) such as a secondary battery or a fuel cell.

For example, the vehicle system 1 includes a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driving operation piece 80, an autonomous driving control device 100, a traveling driving force output device 200, a brake device 210, and a steering device 220. These devices and instruments are connected to each other through a multiplex communication line such as a controller area network (CAN) communication line, a serial communication line, a wireless communication network, or the like. The constituents shown in FIG. 1 are merely an example. Some of the constituents may be omitted, and other constituents may further be added thereto. A combination of the camera 10, the radar device 12, the LIDAR 14, and the object recognition device 16 is an example of “a detection device DD”. The HMI 30 is an example of “an output device”. The autonomous driving control device 100 is an example of “a vehicle control device”.

For example, the camera 10 is a digital camera utilizing a solid-state image capturing element such as a charge coupled device (CCD) or a complementary metal oxide semiconductor (CMOS). The camera 10 is attached to an arbitrary location in the host vehicle M in which the vehicle system 1 is mounted. When images on the side in front are captured, the camera 10 is attached to an upper part of a front windshield, a rear surface of a rearview mirror, a frontal part of a vehicle body, or the like. When images on the side at the rear are captured, the camera 10 is attached to an upper part of a rear windshield, a back door, or the like. When images on a lateral side are captured, the camera 10 is attached to a door mirror or the like. For example, the camera 10 captures images around the host vehicle M periodically and repeatedly. The camera 10 may be a stereo camera.

The radar device 12 radiates radio waves such as millimeter waves around the host vehicle M and detects at least positions (distances and azimuths) of surrounding objects by detecting radio waves (reflected waves) reflected by the objects. The radar device 12 is attached to an arbitrary location in the host vehicle M. The radar device 12 may detect the positions and the speeds of objects by a frequency modulated continuous wave (FM-CW) method.

The LIDAR 14 emits around the host vehicle M and measures scattered light. The LIDAR 14 detects the distance to a target on the basis of the time from light emission to light reception. For example, emitted light is pulsed laser light. The LIDAR 14 is attached to an arbitrary location in the host vehicle M.

The object recognition device 16 recognizes positions, kinds, speeds, and the like of objects by performing sensor fusion processing with respect to detection results of some or all of the camera 10, the radar device 12, and the LIDAR 14. The object recognition device 16 outputs recognition results to the autonomous driving control device 100. The object recognition device 16 may output the detection results of the camera 10, the radar device 12, and the LIDAR 14 to the autonomous driving control device 100 without any change. In this case, the object recognition device 16 may be omitted from the constituents of the vehicle system 1 (detection device DD).

For example, the communication device 20 communicates with different vehicles present around the host vehicle M, a terminal device of a user utilizing the host vehicle M, and various server devices, for example, utilizing a network such as a cellular network, a Wi-Fi network, Bluetooth (registered trademark), dedicated short range communication (DSRC), a local area network (LAN), a wide area network (WAN), and the Internet.

The HMI 30 outputs various information to an occupant of the host vehicle M and receives an input operation of the occupant. For example, the HMI 30 includes various display devices, a speaker, a buzzer, a touch panel, a switch, a key, a microphone, and the like.

The vehicle sensor 40 includes a vehicle speed sensor for detecting the speed of the host vehicle M, an acceleration sensor for detecting the acceleration, a yaw rate sensor for detecting the yaw rate (for example, the rotational angular velocity around a vertical axis passing through the center of gravity of the host vehicle M), an azimuth sensor for detecting the direction of the host vehicle M, and the like. For example, the vehicle sensor 40 may include a tilt angle sensor for detecting the tilt (tilt angle) of the host vehicle M on the basis of a gravitational force or the like. The vehicle sensor 40 may be provided with a position sensor for detecting the position of the vehicle. The position sensor is an example of “a position measurer”. For example, the position sensor is a sensor acquiring positional information (longitude and latitude information) from a global positioning system (GPS) device. The position sensor may be a sensor acquiring positional information using a global navigation satellite system (GNSS) receiver 51 of the navigation device 50. The vehicle sensor 40 may derive the speed of the host vehicle M from a difference in positional information (that is, a distance) at a predetermined time in the position sensor. The results detected by the vehicle sensor 40 are output to the autonomous driving control device 100.

For example, the navigation device 50 includes the GNSS receiver 51, a navigation HMI 52, and a route determiner 53. In the navigation device 50, first map information 54 is retained in a storage device such as a hard disk drive (HDD) or a flash memory. The GNSS receiver 51 identifies the position of the host vehicle M on the basis of a signal received from a GNSS satellite. The position of the host vehicle M may be identified or supplemented by an inertial navigation system (INS) utilizing an output of the vehicle sensor 40. The navigation HMI 52 includes a display device, a speaker, a touch panel, a key, and the like. The GNSS receiver 51 may be provided in the vehicle sensor 40. Some or all of the navigation HMI 52 may be shared by the HMI described above. For example, the route determiner 53 determines a route from the position of the host vehicle M identified by the GNSS receiver 51 (or an arbitrary input position) to a destination input by an occupant (hereinafter, a route on the map) using the navigation HMI 52 with reference to the first map information 54. For example, the first map information 54 is information in which road shapes are expressed by links indicating roads and nodes connected by the links. The first map information 54 may include curvatures of roads, point-of-interest (POI) information, and the like. The route on the map is output to the MPU 60. The navigation device 50 may perform route guidance using the navigation HMI 52 on the basis of the route on the map. The navigation device 50 may transmit a current position and a destination to a navigation server via the communication device 20 and acquire a route equivalent to the route on the map from the navigation server. The navigation device 50 outputs the determined route on the map to the MPU 60.

For example, the MPU 60 includes a recommended lane determiner 61 and retains second map information 62 in a storage device such as an HDD or a flash memory. The recommended lane determiner 61 divides the route on the map provided from the navigation device 50 into a plurality of blocks (for example, divides it into blocks of 100 [m] in a vehicle proceeding direction) and determines a recommended lane for each block with reference to the second map information 62. The recommended lane determiner 61 determines in which lane from the left the vehicle should travel. When a branch point is present in the route on the map, the recommended lane determiner 61 determines a recommended lane such that the host vehicle M can travel along a reasonable route to proceed to a branch destination.

The second map information 62 is map information that is more accurate than the first map information 54. For example, the second map information 62 includes information of the number of lanes, the kinds and the shapes of road demarcation lines (which will hereinafter be referred to as demarcation lines), information of the centers of lanes, information of road boundaries, or the like. The second map information 62 may include information regarding whether or not road boundaries are boundaries including structures through which the vehicle cannot pass (including crossing and contact as well). Examples of structures include guardrails, curbstones, median strips, and fences. The expression “cannot pass through” may include the presence of a small step through which the vehicle can pass if vibration that would not normally occur is tolerated. The second map information 62 may include road shape information, traffic regulation information, address information (address, postal code), facility information, parking lot information, telephone number information, and the like. For example, the road shape information includes curvatures (which may be interpreted as radii of curvature, the same applies below), widths, gradients, and the like of roads. The second map information 62 may be updated at any time by the communication device 20 communicating with an external device. The first map information 54 and the second map information 62 may be integrally provided as map information. The map information may be stored in a storage 190.

For example, the driving operation piece 80 includes a steering wheel, an accelerator pedal, and a brake pedal. The driving operation piece 80 may include a shift lever, a deformed steering wheel, a joystick, and other operation pieces. For example, in each operation piece of the driving operation piece 80, an operation detector for detecting the amount of operation or the presence or absence of operation of the operation piece by an occupant is attached. For example, the operation detector detects the steering angle and the steering torque of the steering wheel, the stepped amounts of the accelerator pedal and the brake pedal, and the like. Further, the operation detector outputs detection results to one of or both the autonomous driving control device 100, and the traveling driving force output device 200, the brake device 210, and the steering device 220.

The autonomous driving control device 100 executes various driving control which belong to autonomous driving for the host vehicle M. For example, the autonomous driving control device 100 includes a first controller 120, a second controller 160, an HMI controller 180, and the storage 190. Each of the first controller 120, the second controller 160, and the HMI controller 180 is realized by a hardware processor such as a central processing unit (CPU), for example, executing a program (software). Some or all of these constituent elements may be realized by hardware (circuit; including circuitry) such as a large scale integration (LSI), an application specific integrated circuit (ASIC), a field-programmable gate array (FPGA), a graphics processing unit (GPU), or a system on chip (SOC), or may be realized by software and hardware in cooperation. The program described above may be stored in a storage device such as an HDD or a flash memory (a storage device including a non-transitory storage medium) of the autonomous driving control device 100 in advance or may be stored in an attachable/detachable storage medium such as a DVD, a CD-ROM, or a memory card such that the program is installed in the storage device of the autonomous driving control device 100 when the storage medium (non-transitory storage medium) is mounted in a drive device, a card slot, or the like.

The storage 190 may be realized by the foregoing various storage devices, an electrically erasable programmable read only memory (EEPROM), a read only memory (ROM), or a random access memory (RAM), or the like. For example, the storage 190 stores various information, programs, and the like in the embodiment. The storage 190 may store map information (for example, the first map information 54 and the second map information 62).

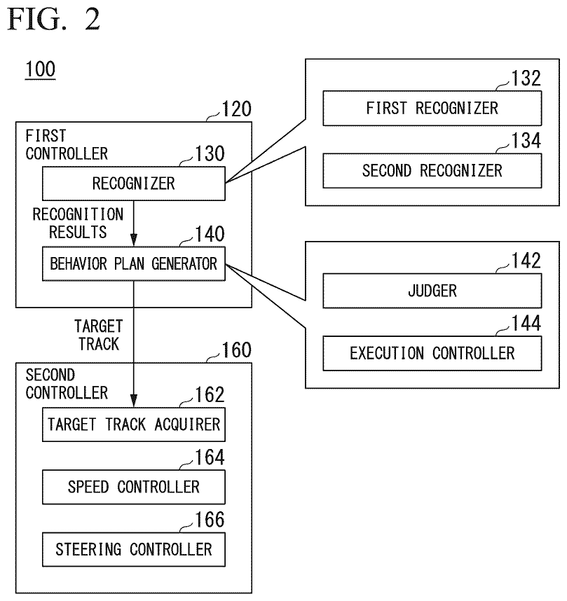

FIG. 2 is a view of functional constitutions of the first controller 120 and the second controller 160. For example, the first controller 120 includes a recognizer 130 and a behavior plan generator 140. For example, the first controller 120 realizes functions based on artificial intelligence (AI) and functions based on a model which has been given in advance in parallel. For example, a function of “recognizing an intersection” may be realized by executing recognition of an intersection using deep learning or the like and recognition based on conditions which have been given in advance (such as traffic lights, road signs, or the like which can be subjected to pattern matching) in parallel, scoring both, and evaluating them comprehensively. Accordingly, the reliability of autonomous driving is ensured. For example, the first controller 120 executes control related to autonomous driving of the host vehicle M on the basis of an instruction from the MPU 60, the HMI controller 180, or the like.

The recognizer 130 recognizes the surrounding situation of the host vehicle M on the basis of recognition results (information input from the camera 10, the radar device 12, and the LIDAR 14 via the object recognition device 16) of the detection device DD. For example, the recognizer 130 recognizes the states, such as positions, speeds, and accelerations, of objects present around the host vehicle M (within a predetermined distance). Examples of objects include different vehicles (surrounding vehicles), traffic participants (pedestrians, bicycles, and the like) passing along the road, road structures, and other objects such as obstacles present around the vehicle. Examples of road structures include road signs, traffic lights, railroad crossings, curbstones, median strips, guardrails, and fences. For example, the position of an object is recognized as a position on absolute coordinates with an origin at a representative point (the centroid, the drive shaft center, or the like) in the host vehicle M and is used for control. The position of an object may be represented by a representative point such as the centroid or a corner of the object or may be represented by an expressed region. For example, when an object is a mobile object such as a different vehicle, “the state” of an object may include an acceleration or a jerk of the mobile object or “a behavior state” (for example, whether or not a different vehicle is making or attempting a lane change).

For example, the recognizer 130 includes a first recognizer 132 and a second recognizer 134. The functions thereof will be described below in detail.

The behavior plan generator 140 generates a behavior plan for causing the host vehicle M to travel by autonomous driving on the basis of recognition results of the recognizer 130 and the like. For example, in principle, the behavior plan generator 140 generates a target track along which the host vehicle M will travel autonomously (without relying on driver's operation) in the future so as to be able to travel in a recommended lane determined by the recommended lane determiner 61 and to respond to the surrounding situation of the host vehicle M on the basis of recognition results of the recognizer 130, the shapes of surrounding roads based on the current position of the host vehicle M acquired from the map information, and the like. For example, a target track includes a speed element. For example, a target track is expressed as an ordered sequence of spots (track points) at which the host vehicle M should arrive. The track points are spots at which the host vehicle M should arrive at intervals of a predetermined traveling distance (for example, approximately several [m]) along a road, and separately, a target speed and a target acceleration at intervals of a predetermined sampling time (for example, approximately a few tenths of [sec]) are generated as a part of the target track. The track points may be positions which are set at intervals of a predetermined sampling time and at which the host vehicle M should arrive at each sampling time. In this case, information of the target speed and the target acceleration is expressed by the intervals between the track points.

When a target track is generated, the behavior plan generator 140 may set events of autonomous driving. Examples of events include a constant speed traveling event of causing the host vehicle M to travel in the same lane at a constant speed, a following traveling event of causing the host vehicle M to follow a different vehicle which is present ahead of the host vehicle M within a predetermined distance (for example, within 100 [m]) and closest to the host vehicle M, a lane change event of causing the host vehicle M to make a lane change from the current lane to an adjacent lane, a branching event of causing the host vehicle M to branch into a lane on a destination side at a branching spot on the road, a merging event of causing the host vehicle M to merge with a main line at a merging spot, and a takeover event of terminating autonomous driving and switching to manual driving. Examples of events may include an overtaking event of causing the host vehicle M to temporarily make a lane change to an adjacent lane and to make a lane change again to the original lane after overtaking a preceding vehicle in the adjacent lane, and an avoidance event of causing the host vehicle M to perform at least one of braking and steering to avoid an obstacle present ahead of the host vehicle M.

For example, the behavior plan generator 140 may change an event which has already been determined for the current section to a different event depending on the surrounding situation of the host vehicle M recognized while the host vehicle M is traveling, or may set a new event for the current section. The behavior plan generator 140 may change an event which has already been set for the current section to a different event in response to an operation of an occupant on the HMI 30, or may set a new event for the current section. The behavior plan generator 140 generates a target track corresponding to the set event.

For example, the behavior plan generator 140 includes a judger 142 and an execution controller 144. The functions thereof will be described below in detail. For example, the recognizer 130 and the judger 142 are examples of “a judgment device”. The execution controller 144 and the second controller 160 are examples of “a driving controller”.

The second controller 160 controls the traveling driving force output device 200, the brake device 210, and the steering device 220 such that the host vehicle M passes through a target track generated by the behavior plan generator 140 at a scheduled time.

For example, the second controller 160 includes a target track acquirer 162, a speed controller 164, and a steering controller 166. The target track acquirer 162 acquires information of a target track (track points) generated by the behavior plan generator 140 and stores it in a memory (not shown). The speed controller 164 controls the traveling driving force output device 200 or the brake device 210 on the basis of a speed element associated with the target track stored in the memory. The steering controller 166 controls the steering device 220 in accordance with the curvature of the target track stored in the memory. For example, processing of the speed controller 164 and the steering controller 166 is realized by a combination of feedforward control and feedback control. As an example, the steering controller 166 executes feedforward control corresponding to the curvature of the road ahead of the host vehicle M and feedback control based on the deviation from the target track in combination.

Returning to FIG. 1, the HMI controller 180 notifies an occupant of predetermined information via the HMI 30. Examples of predetermined information include information related to traveling of the host vehicle M, such as information related to the state of the host vehicle M and information related to driving control. Examples of information related to the state of the host vehicle M include the speed, the engine rotation frequency, and the shift position of the host vehicle M. Examples of information related to driving control include the presence or absence of execution of driving control by autonomous driving, information inquiring whether or not to start autonomous driving, information related to driving control conditions by autonomous driving, information related to automation level, and information for prompting an occupant to perform driving when switching from autonomous driving to manual driving. Predetermined information may include information which is not related to traveling of the host vehicle M, such as TV programs and contents stored in a storage medium such as a DVD (for example, movies). Examples of predetermined information may include a current position and a destination in autonomous driving, and information related to the remaining fuel level of the host vehicle M. The HMI controller 180 may output the information received via the HMI 30 to the communication device 20, the navigation device 50, the first controller 120, and the like.

The HMI controller 180 may cause the HMI 30 to output inquiry information for an occupant, processing results of the first controller 120 and the second controller 160, and the like. The HMI controller 180 may transmit various information output by the HMI 30 to the terminal device utilized by a user of the host vehicle M via the communication device 20.

The traveling driving force output device 200 outputs a traveling driving force (torque) for the vehicle to travel to driving wheels. For example, the traveling driving force output device 200 includes a combination of an internal-combustion engine, an electric motor, a transmission, and the like, and an electronic control unit (ECU) for controlling these. The ECU controls the foregoing constituents in accordance with the information input from the second controller 160 or the information input from the accelerator pedal of the driving operation piece 80.

For example, the brake device 210 includes a brake caliper, a cylinder transmitting a hydraulic pressure to the brake caliper, an electric motor generating a hydraulic pressure in the cylinder, and a brake ECU. The brake ECU controls the electric motor in accordance with the information input from the second controller 160 or the information input from the brake pedal of the driving operation piece 80 so that a brake torque corresponding to a braking operation is output to each of the wheels. The brake device 210 may include, as a backup, a mechanism for transmitting a hydraulic pressure generated by an operation of the brake pedal to the cylinder via a master cylinder. The brake device 210 is not limited to the constitution described above and may be an electronically controlled hydraulic brake device transmitting a hydraulic pressure of the master cylinder to the cylinder by controlling an actuator in accordance with the information input from the second controller 160.

For example, the steering device 220 includes a steering ECU and an electric motor. For example, the electric motor causes a force to act on a rack-and-pinion mechanism to change the direction of steered wheels. The steering ECU drives the electric motor in accordance with the information input from the second controller 160 or the information input from the steering wheel of the driving operation piece 80 to change the direction of the steered wheels.

### [Recognizer and Behavior Plan Generator]

Next, the functions of the recognizer 130 (the first recognizer 132 and the second recognizer 134) and the behavior plan generator 140 (the judger 142 and the execution controller 144) will be described in detail. Hereinafter, judgment processing in the embodiment and details of driving control (traveling control) based on judgment results will be mainly described in several scenes.

### [First Scene]

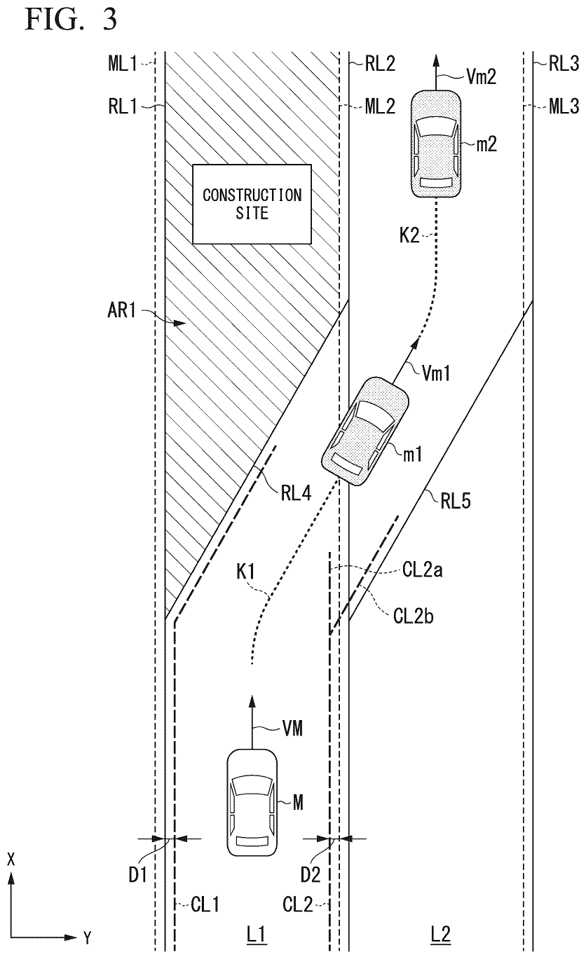

FIG. 3 is an explanatory view of judgment processing and driving control in a first scene. The example of FIG. 3 shows demarcation lines CL1 and CL2 recognized by the detection device DD, demarcation lines ML1 to ML3 obtained from the map information (for example, the second map information 62) on the basis of positional information of the host vehicle M, and demarcation lines RL1 to RL5 actually drawn on the road. In the map information, a lane L1 is demarcated by the demarcation lines ML1 and ML2, and a lane L2 is demarcated by the demarcation lines ML2 and ML3. The lanes L1 and L2 are lanes capable of proceeding in the same direction (X axis direction in the diagram). In the example of FIG. 3, the demarcation line CL1 and CL2 are examples of “a first demarcation line”, and the demarcation lines ML1 to ML3 are examples of “a second demarcation line”. In the example of FIG. 3, the host vehicle M is traveling on the lane L1 at a speed VM.

In the first scene, different vehicles m1 and m2 are present around the host vehicle M. In the example of FIG. 3, the different vehicle m1 is traveling ahead of the host vehicle M at a speed Vm1, and the different vehicle m2 is traveling ahead of the host vehicle M (different vehicle m1) at a speed Vm2. In FIG. 3, a road construction site is present on the lane L1, and temporary demarcation lines RL4 and RL5 are drawn to allow vehicles to travel while avoiding entry to a traveling prohibited region AR1 including the construction site. During construction, vehicles traveling in the lane L1 can travel while avoiding entry to the traveling prohibited region AR1 by traveling in a region demarcated by the demarcation lines RL4 and RL5 and moving to the lane L2 side.

The first recognizer 132 recognizes the surrounding situation of the host vehicle M on the basis of an output of the detection device DD which has detected the surrounding situation of the host vehicle M. For example, the first recognizer 132 recognizes the demarcation lines CL1 and CL2 on the left and right demarcating the traveling lane (lane L1) of the host vehicle M on the basis of images captured by the camera 10 (hereinafter, camera images). The first recognizer 132 may recognize demarcation lines demarcating an adjacent lane (lane L2) adjacent to the traveling lane. Hereinafter, the demarcation lines CL1 and CL2 may be referred to as “camera demarcation lines CL1 and CL2”.

For example, the first recognizer 132 analyzes the camera images, extracts edge points having a greater luminance difference with respect to adjacent pixels in the images, and connect the edge points, thereby recognizing each of the camera demarcation lines CL1 and CL2 in the image plane. The first recognizer 132 converts the positions of the camera demarcation lines CL1 and CL2 into a vehicle coordinate system (for example, XY plane coordinates in FIG. 3) based on the position of the representative point in the host vehicle M. The first recognizer 132 may recognize the curvature or the amount of change in curvature of each of the camera demarcation lines CL1 and CL2. For example, the amount of change in curvature is the rate of change over time in curvature of the camera demarcation lines CL1 and CL2, which have been recognized by the camera 10, at a distance of X [m] ahead when viewed from the host vehicle M. The first recognizer 132 may recognize the curvature or the amount of change in curvature of the lane demarcated by the camera demarcation lines CL1 and CL2 by averaging the curvature or the amount of change in curvature of each of the camera demarcation lines CL1 and CL2. The camera demarcation lines CL1 and CL2 may be recognized or corrected on the basis of an output of a detection device other than the camera 10.

When a plurality of one side camera demarcation lines of the left and right camera demarcation lines for the host vehicle M are present on at least one side due to branching (branch road) or the, the first recognizer 132 recognizes each of the demarcation lines. In the example of FIG. 3, it is assumed that a plurality of camera demarcation lines CL2a and CL2b are recognized from the middle of the camera demarcation line CL2 on the right side of the host vehicle M. The camera demarcation line CL2a is an example of “a first one side first demarcation line” or “a first one side camera demarcation line”, and the demarcation line CL2b is an example of “a second one side first demarcation line” or “a second one side camera demarcation line”. The first recognizer 132 recognizes a construction site, the traveling prohibited region AR1, obstacles, and the like present in the proceeding direction.

The first recognizer 132 recognizes different vehicles present around the host vehicle M (within a predetermined distance). For example, the first recognizer 132 recognizes the different vehicles m1 and m2 present ahead of the host vehicle M on the basis of an output of the detection device DD which has detected the surrounding situation of the host vehicle M. The first recognizer 132 recognizes the position (relative position with respect to the host vehicle M) and the speed (relative speed with respect to the host vehicle M) of each of the different vehicles m1 and m2. The first recognizer 132 may recognize traveling positional information of the different vehicles m1 and m2. For example, traveling positional information includes traveling trajectories K1 and K2 based on positions of the representative point of each of the different vehicles m1 and m2 during traveling at a predetermined time. For example, traveling positional information may include information related to estimated traveling tracks of the different vehicles m1 and m2 in the future based on the traveling trajectories K1 and K2 and the directions of the different vehicles m1 and m2.

For example, the second recognizer 134 recognizes the demarcation lines of the lanes around the host vehicle M (within a predetermined distance) from the map information on the basis of the position of the host vehicle M detected by the vehicle sensor 40 or the GNSS receiver 51. For example, the second recognizer 134 recognizes the demarcation lines ML1 to ML3 present in a direction in which the host vehicle M is proceeding or the host vehicle M can proceed with reference to the map information on the basis of the positional information of the host vehicle M. Hereinafter, the demarcation lines ML1 to ML3 may be referred to as “map demarcation lines ML1 to ML3”.

The second recognizer 134 may recognize the map demarcation lines ML1 and ML2, of the recognized map demarcation lines ML1 to ML3, as the demarcation lines demarcating the lane L1 in which the host vehicle M will travel. The second recognizer 134 recognizes the curvature or the amount of change in curvature of each of the map demarcation lines ML1 to ML3 from the map information. The second recognizer 134 may recognize the curvature or the amount of change in curvature for each of the lanes L1 and L2 demarcated by the map demarcation lines by averaging the curvature or the amount of change in curvature of each of the map demarcation lines ML1 to ML3.

For example, the judger 142 performs correctness judgment as to whether or not at least one of the camera demarcation lines CL and the map demarcation lines ML is correct on the basis of at least one of the camera demarcation lines CL (CL1 and CL2) and the map demarcation lines ML (ML1 to ML3), and the traveling trajectories K1 and K2 of the different vehicles m1 and m2. The execution controller 144, on the basis of the judgment results of the judger 142, generates a target track for performing driving control by controlling one of or both the steering and the speed of the host vehicle M such that the host vehicle M will travel along the demarcation lines judged to be correct, generates a target track for performing driving control so as to avoid contact with obstacles, performs control of terminating driving control (or does not start driving control) when both the demarcation lines are judged to be incorrect, and the like.

In the example of FIG. 3, regarding correctness judgment, the judger 142 first judges whether or not the camera demarcation lines CL (CL1 and CL2) recognized by the first recognizer 132 and the map demarcation lines ML (ML1 and ML2) recognized by the second recognizer 134 match each other. For example, the judger 142 derives the matching degree between the demarcation lines CL1 and ML1 present at the closest position on the left side when viewed from the host vehicle M, and the matching degree between the demarcation lines CL2 and ML2 present at the closest position on the right side when viewed from the host vehicle M. Further, when the derived matching degrees are equal to or larger than a threshold, the judger 142 judges that the camera demarcation lines CL and the map demarcation lines ML match each other, and when the matching degrees are smaller than the threshold, it is judged that they do not match. Such matching judgment described above is repeatedly executed at predetermined timing intervals or in a predetermined cycle.

For example, the judger 142 superimposes the camera demarcation lines CL1 and CL2 and superimposes the map demarcation lines ML1 and ML2 based on the position of the representative point in the host vehicle M in a plane (XY plane) of the vehicle coordinate system. Further, the judger 142 judges the matching degrees of comparison target demarcation lines (the demarcation lines CL1 and ML1 and the demarcation lines CL2 and ML2). For example, the matching degree is an index value related to the amount of deviation in the lateral position (for example, the Y axis direction in the diagram), and the matching degree increases as the amount of deviation decreases. For example, the matching degree corresponding to the amount of deviation may be derived by a predetermined function having the amount of deviation as an input and the matching degree as an output or may be derived using a table or the like in which the amount of deviation and the matching degree are associated. In the example of FIG. 3, the matching degree corresponding to each of an amount of deviation D1 in the lateral positions of the demarcation lines CL1 and ML1 and an amount of deviation D2 in the lateral positions of the demarcation lines CL2 and ML2 may be derived, or the matching degree may be derived on the basis of the average value, the largest value, or the smallest value of the amounts of deviation D1 and D2. As shown in FIG. 3, regarding the part in which a plurality of one side camera demarcation lines CL2 are present, the matching degree between each of the camera demarcation lines CL2a and CL2b and the map demarcation line ML2 is derived.

For example, the matching degree may be an index value related to an angle (deviation angle) formed by two comparison target demarcation lines in place of (or in addition to) the amount of deviation in the lateral position described above. In this case, the matching degree increases as the deviation angle decreases. In the example of FIG. 3, the matching degree may be derived from each of the deviation angle formed by the demarcation lines CL1 and ML1 and the deviation angles formed by the demarcation lines CL2 (CL2a and CL2b) and ML2, or the matching degree may be derived on the basis of the average value, the largest value, or the smallest value of each of the angles.

The matching degree may be an index value related to the difference between the amounts of change in curvature of the demarcation lines in place of (or in addition to) the amount of deviation in the lateral position or the deviation angle of the demarcation lines described above. In this case, the matching degree increases as the difference between the amounts of change in curvature decreases. The amount of change in curvature is mainly used when the lane is on a curved road. The judger 142 may derive the matching degree on the basis of the average value of the difference between the amounts of change in curvature of the demarcation lines CL1 and ML1 and the difference between the amounts of change in curvature of the demarcation lines CL2 (CL2a and CL2b) and ML2, or may derive the matching degree on the basis of the largest value or the smallest value of the difference. The judger 142 may derive the matching degree from the difference between the average value of the amounts of change in curvature of the demarcation lines CL1 and CL2 and the average value of the amounts of change in curvature of the demarcation lines ML1 and ML2, or may derive the matching degree on the basis of the difference between the amount of change in curvature of the lane (lane L1) recognized from the camera images and the amount of change in curvature of the lane L1 recognized from the map information. The matching degree corresponding to the difference between the deviation angles or the amounts of change in curvature may be derived, for example, using a predetermined function, a corresponding table, or the like similarly to the amounts of deviation.

For example, when the accuracy of recognizing the camera demarcation lines CL1 and CL2 (CL2a and CL2b) recognized by the first recognizer 132 falls below the threshold, or when the camera demarcation lines CL cannot be recognized any longer, the judger 142 may derive the matching degree using the angles formed by the traveling trajectories K1 and K2 of the different vehicles m1 and m2 and the map demarcation lines ML traveling around. The judger 142 may set a virtual demarcation line parallel to the traveling trajectories K1 and K2 and derive the matching degrees between the set virtual demarcation line and the map demarcation lines ML. The judger 142 may perform matching judgment of the demarcation lines using the traveling trajectories K1 and K2 regardless of the recognition results of the camera demarcation lines CL. In addition, similarly, when recognized by the camera demarcation lines CL and the surrounding map demarcation lines ML cannot be recognized from the map information, the judger 142 may perform matching judgment between the camera demarcation lines CL and the traveling trajectories K1 and K2 and judge whether or not the camera demarcation lines CL are correct from the judgment results. The judger 142 may perform matching judgment between the camera demarcation lines CL and the traveling trajectories K1 and K2 regardless of the recognition results of the map demarcation lines ML.

When it is judged that the camera demarcation lines CL and the map demarcation lines ML match each other by the matching judgment using the matching degree described above, the judger 142 judges that the camera demarcation lines CL and the map demarcation lines ML are correct demarcation lines in the correctness judgment. When it is judged that the camera demarcation lines CL and the map demarcation lines ML do not match each other, the judger 142 may judge that at least one of the camera demarcation lines CL and the map demarcation lines ML is incorrect. For example, when the camera demarcation lines CL and the map demarcation lines ML do not match each other, and when the host vehicle M is performing driving control to avoid an obstacle ahead, the judger 142 may judge that the camera demarcation lines CL are incorrect (or the map demarcation lines ML are correct).

When the camera demarcation lines CL and the map demarcation lines ML do not match each other, and when traveling trajectories equal to or more than a predetermined number, of traveling trajectories of a plurality of recognized different vehicle, are traveling trajectories along the map demarcation lines ML (including a predetermined tolerance range), the judger 142 may judge that the camera demarcation lines CL are incorrect (or the map demarcation lines ML are correct). When the camera demarcation lines CL and the map demarcation lines ML do not match each other, and when traveling trajectories equal to or more than a predetermined number, of traveling trajectories of a plurality of recognized different vehicle, are traveling trajectories along the camera demarcation lines CL (including a predetermined tolerance range), the judger 142 may judge that the map demarcation lines ML are incorrect (or the camera demarcation lines CL are correct). For example, when the matching degree is small beyond the lower limit value which is smaller than the threshold, the judger 142 may judge that the camera demarcation lines and the map demarcation lines are incorrect.

Here, for example, when a plurality of camera demarcation lines on one side of the camera demarcation lines CL1 and CL2 on both the left and right sides of the traveling lane L1 of the host vehicle M are recognized by the first recognizer 132, the first one side camera demarcation lines included in the plurality of recognized one side camera demarcation lines and the map demarcation lines ML match each other, and predetermined conditions are satisfied, the judger 142 reduces the reliability of the matching information of the first one side camera demarcation lines and the second demarcation lines which have matched each other. Matching information is a matching degree, for example, and reducing the reliability is reducing the matching degree, for example. Matching information may be judgment results of correctness judgment of the demarcation lines.

In the example of FIG. 3, the camera demarcation line CL2 on one side of the camera demarcation lines CL1 and CL2 is recognized in a manner of branching into two lines, and the camera demarcation line CL2a and the map demarcation line ML2 which are the first one side camera demarcation lines of the plurality of recognized camera demarcation lines CL2a and CL2b match each other (the matching degree is equal to or larger than the threshold). In this case, when the predetermined conditions are further satisfied, the judger 142 reduces the matching degree between the camera demarcation line CL2a and the map demarcation line ML2 so that the map demarcation line ML2 is unlikely to be judged to be a correct demarcation line. The judger 142 may reduce the reliability of the judgment results of correctness judgment. When the reliability of the judgment results is reduced, the judger 142 does not judge that the map demarcation line ML2 is a correct demarcation line.

For example, the predetermined conditions are that the different vehicles m1 and m2 traveling ahead of the host vehicle M pass over the map demarcation line ML2 (or over the camera demarcation line CL2a) which has been judged to match. The expression “passing over” denotes that a predetermined position (for example, the center, the centroid, or the tip) or the entire vehicle body of the different vehicles m1 and m2 crosses (or straddles) the map demarcation line ML2 and moves to a different lane (adjacent lane) or the like. For example, whether or not the different vehicles m1 and m2 have passed over the map demarcation line ML2 may be judged from their behavior or may be judged on the basis of the traveling trajectories K1 and K2. In this manner, when the different vehicles m1 and m2 have passed over the demarcation line judged to match, there is a high probability that the traveling path along the foregoing demarcation line is not a correct traveling path. Therefore, misjudgment of the demarcation line or the road shape can be curbed by reducing the reliability of the matching information.

The predetermined conditions described above may include that different vehicles equal to or more than a predetermined number traveling ahead of the host vehicle M have passed over the map demarcation line ML2 (or over the camera demarcation line CL2a). For example, when there is only one different vehicle passing over the map demarcation line ML2, there is a probability that the different vehicle is making a lane change from the lane L1 to the lane L2. Therefore, the demarcation line or the road shape can be judged more accurately by including as a condition that a predetermined number of (two or more) different vehicles have passed. The predetermined conditions described above may include that all different vehicles traveling ahead of the host vehicle M in the traveling lane (lane L1) of the host vehicle M have passed over the map demarcation line ML2 (or over the camera demarcation line CL2a).

For example, the predetermined conditions may include that the host vehicle M is traveling within a predetermined distance range nearer than a construction site (or the traveling prohibited region AR1 including the construction site). A construction site may be a construction site under construction or may be a construction site after construction, at which construction has been carried out (in the past (predetermined hours ago). For example, whether or not the spot is under construction is judged from road signs or signboards indicating construction, construction vehicles, construction workers, road physical boundaries (which will be described below), and the like recognized by the first recognizer 132. For example, whether or not construction has been carried out in the past is judged by acquiring construction histories of the surrounding areas based on the positional information of the host vehicle M from a server or the like managing construction histories and the like via the communication device 20 or the like. There is a high probability that the road is under an environment in which temporarily drawn demarcation lines remain during construction or for a predetermined period after construction. Therefore, in this case, misjudgment with respect to the demarcation lines (road shapes based on the demarcation lines) can be curbed by reducing the reliability of the matching information.

For example, when the conditions described above are satisfied and the reliability of the matching information is reduced, and when a one side camera demarcation line, of a plurality of recognized one side camera demarcation lines, which does not match the map demarcation line is present, the execution controller 144 may execute driving control of causing the host vehicle M to travel along the one side camera demarcation line. In the example of FIG. 3, the camera demarcation line CL2b which is the second one side camera demarcation line of a plurality of recognized one side camera demarcation lines CL2a and CL2b does not match any of the map demarcation lines ML1 to ML3. Therefore, the execution controller 144 generates a target track such that the host vehicle M travels along the camera demarcation line CL2b in a section in which the camera demarcation line CL2 branches, and causes the host vehicle M to travel along the generated target track. There is a high probability that the camera demarcation line CL2b is a newly drawn demarcation line due to construction, traveling control of the host vehicle M by autonomous driving can continue by causing the host vehicle M to travel along this.

In this manner, according to the first scene, for example, even when information related to construction (road information for under construction or after construction) is not reflected in the map information during construction or after construction, misjudgment with respect to the demarcation lines (road shapes based on the demarcation lines) can be curbed. Since traveling along a wrong route is curbed, operation of the autonomous brake or execution of switching control from autonomous driving to manual driving can be curbed so that driving control can continue.

### [Second Scene]

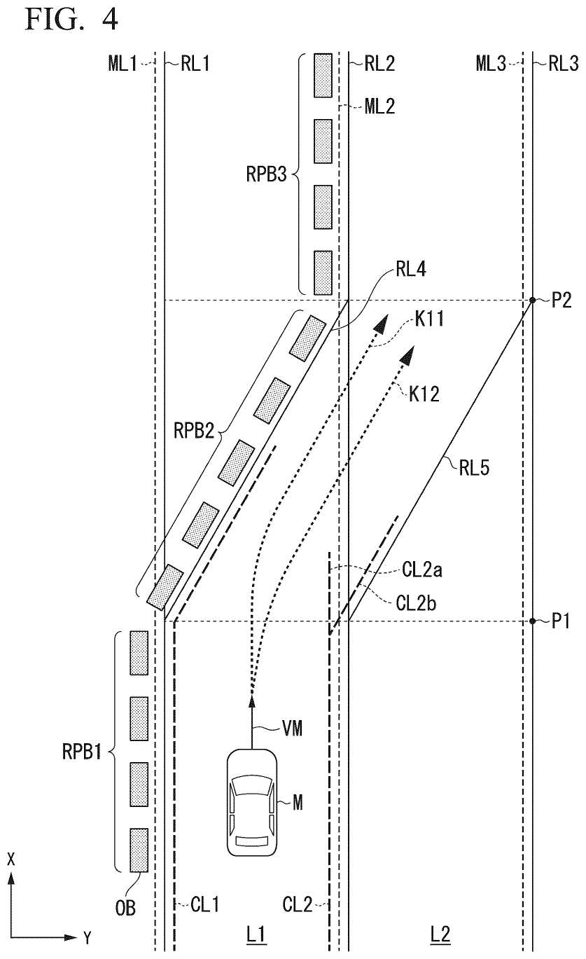

FIG. 4 is an explanatory view of judgment processing and driving control in a second scene. Compared to the first scene shown in FIG. 3, the example of FIG. 4 differs in that no different vehicle is present around the host vehicle M, and further, road physical boundaries RPB are present. For example, the road physical boundaries RPB are boundaries constituted of objects OB (for example, fences, safety fences, barricades, or Pylons (registered trademark)) installed on the road for demarcating a traveling path different from the demarcation line which has been drawn on the road in advance. For example, the road physical boundaries RPB are installed to curb entry of vehicles to the traveling prohibited region. A plurality of objects OB may be provided, or a plurality of objects OB may be arrayed or connected. In the example of FIG. 4, when viewed from the host vehicle M, a road physical boundary RPB1 are present along the demarcation line RL1 up to a spot P1, a road physical boundary RPB2 are present along the demarcation line RL4 from the spot P1 to a spot P2, and a road physical boundary RPB3 are present along the demarcation line RL2 after the spot P2. The road physical boundaries RPB1 to RPB3 may be physical boundaries which are connected or integrated.

In the second scene as well, when a plurality of camera demarcation lines on one side of the camera demarcation lines CL1 and CL2 on both the left and right sides of the traveling lane L1 of the host vehicle M are recognized by the first recognizer 132, the first one side camera demarcation lines included in the plurality of recognized one side camera demarcation lines and the map demarcation lines ML match each other, and predetermined conditions are satisfied, the judger 142 reduces the reliability of the matching information of the first one side camera demarcation lines and the second demarcation lines which have matched each other. Here, for example, the predetermined conditions in the second scene are that the road physical boundaries RPB (RPB1 to RPB3) are present in the proceeding direction of the host vehicle M. For example, as shown in the road physical boundary RPB2 in FIG. 4, there is a high probability at least a part of the road physical boundaries RPB is not disposed along the map demarcation lines ML1 to ML3 registered in the map information. For this reason, the road physical boundaries RPB do not match the map demarcation line (the matching degree with respect to the map demarcation line is low). Therefore, the judger 142 can curb misjudgment with respect to the demarcation lines (road shapes based on the demarcation lines) by including as a predetermined condition that the road physical boundaries RPB are present in the proceeding direction of the host vehicle M.

In the second scene, when the road physical boundaries RPB extending in a direction differing from the extending directions of the camera demarcation line CL2a and the map demarcation line ML2 which have matched by a predetermined angle or greater are present, the execution controller 144 may execute driving control of causing the host vehicle M to travel along the road physical boundaries RPB. In the example of FIG. 4, it is assumed that the road physical boundary RPB2 extend in a direction differing from the extending directions of the camera demarcation line CL2a and the map demarcation line ML2 which have matched by a predetermined angle or greater. In this case, the execution controller 144 generates a target track K11 such that the host vehicle M travels along the road physical boundary RPB2 in a section between the spots P1 to P2 in which the road physical boundary RPB2 is present, and causes the host vehicle M to travel along the generated target track K11.

In this manner, according to the second scene, it is judged that the disposition direction of the road physical boundaries RPB is a direction in which the vehicle can travel while avoiding entry to a traveling prohibited region including a construction site or the like, and the vehicle is caused to travel along the road physical boundaries RPB. Therefore, misjudgment with respect to the demarcation lines (road shapes based on the demarcation lines) can be curbed, and driving control can continue.

The judger 142 may perform correctness judgment of the camera demarcation lines CL on the basis of the road physical boundaries RPB. In this case, for example, when a plurality of camera demarcation lines on one side are recognized and one of them (for example, a camera demarcation line which does not match the map demarcation line) extends in the extending direction of the road physical boundaries RPB (or in parallel to the extending direction of the road physical boundaries RPB), the judger 142 judges that the camera demarcation line is a correct demarcation line. In the example of FIG. 4, the camera demarcation line CL2b which is the second one side camera demarcation line not matching the map demarcation line extends along the extending direction of the road physical boundary RPB2. Therefore, the judger 142 judges that the camera demarcation line CL2b is a correct demarcation line.

When it is judged that the camera demarcation line CL2b is a correct demarcation line, the execution controller 144 generates a target track such that the host vehicle M travels along the camera demarcation line CL2b and causes the host vehicle M to travel along the generated target track. Here, as described above, when traveling along the road physical boundaries RPB is performed, there is a need to cause the host vehicle M to travel at a position with a predetermined interval from the road physical boundaries RPB in order to avoid contact between the road physical boundaries RPB and the host vehicle M. However, even if the camera demarcation line CL2b comes into contact with the host vehicle M (for example, even if the host vehicle M travels over the camera demarcation line CL2b), there is no significant influence. For this reason, the execution controller 144 can generate a target track K12 at a position farther away from the road physical boundary RPB2 than the target track K11 by generating the target track K12 for causing the host vehicle M to travel along the camera demarcation line CL2b. Therefore, the host vehicle M can travel more safely.

When the distance between the camera demarcation line CL2b and the road physical boundary RPB2 is short (shorter than a predetermined distance), the execution controller 144 may adjust the position of the camera demarcation line CL2b and then may perform driving control of causing the host vehicle M to travel along the camera demarcation line CL2b. In this case, the execution controller 144 adjusts the position of the camera demarcation line CL2b such that the distance between the camera demarcation line CL2b and the road physical boundary RPB2 becomes equal to or longer than a predetermined distance. For example, a predetermined distance is a distance at which the road physical boundary RPB2 and the host vehicle M do not contact with each other even when a predetermined position (for example, a right side surface part, the center, or the centroid) in the host vehicle M travels over the camera demarcation line CL2b (further, it may be a distance including a predetermined safety margin). A predetermined distance may be a fixed distance or may be variably set on the basis of the vehicle width of the host vehicle M or the width of the lane L1.

In this manner, even when the camera demarcation line CL2b and the road physical boundary RPB2 are close to each other, the target track K12 traveling at the position where the host vehicle M does not come into contact with the road physical boundary RPB2 can be generated and the host vehicle M can be caused to travel by adjusting the position of the camera demarcation line CL2b. Moreover, the host vehicle M can travel at a position away from the road physical boundary RPB2. Therefore, it is possible to curb a situation in which an occupant of the host vehicle M feels anxious about the probability of contact with the road physical boundary RPB2.

The execution controller 144 may generate a target track on the basis of the camera demarcation line CL1 and cause the host vehicle M to travel along the generated target track instead of generating a target track on the basis of the camera demarcation line CL2b as described above. In this case, for example, the execution controller 144 generates a target track using a part of the camera demarcation line CL1, which does not match the map demarcation line ML1 and deviates, along the road physical boundary RPB2. Accordingly, adjustment can be made such that the host vehicle M travels at a position reliably away from the road physical boundary RPB2. In this manner, in the embodiment, a target track can be generated and the host vehicle M can be caused to travel at a more appropriate position (for example, a position away from the road physical boundaries) using the camera demarcation line CL2b present on the same side as that judged to match or a part of the camera demarcation line CL1 on a side not judged to match (a side which has been excluded once).

In the second scene, when the host vehicle M is traveling on a road having a gradient equal to or larger than a predetermined value (lane L1), the execution controller 144 may not execute driving control based on the road physical boundaries RPB. For example, the gradient of a road may be acquired from the second map information 62 on the basis of the positional information of the host vehicle M or may be acquired on the basis of the tilt (tilt angle) of the host vehicle M detected by the vehicle sensor 40.

When the host vehicle M is traveling on a road with a gradient, the accuracy of recognizing the position, the shape, the size, and the like of the road physical boundaries RPB (objects OB) is further degraded than that during traveling on a level road. Therefore, when the host vehicle M is traveling on a road having a gradient equal to or larger than a predetermined value, the execution controller 144 generates no target track for causing the host vehicle M to travel along the road physical boundaries RPB. Accordingly, it is possible to curb execution of driving control based on a wrong target track during traveling on a road with a gradient.

When the host vehicle M is traveling on a road having a gradient equal to or larger than a predetermined value (lane L1), correctness judgment of the demarcation lines based on the road physical boundaries RPB may not be performed instead of not executing driving control based on the road physical boundaries RPB.

According to the second scene described above, for example, even in a situation in which no different vehicle is present around, misjudgment with respect to the demarcation lines (road shapes based on the demarcation lines) can be curbed on the basis of the road physical boundaries RPB. Driving control can continue by generating a target track at an appropriate position on the basis of the road physical boundaries RPB and causing the host vehicle M to travel along the generated target track.

### [Third Scene]

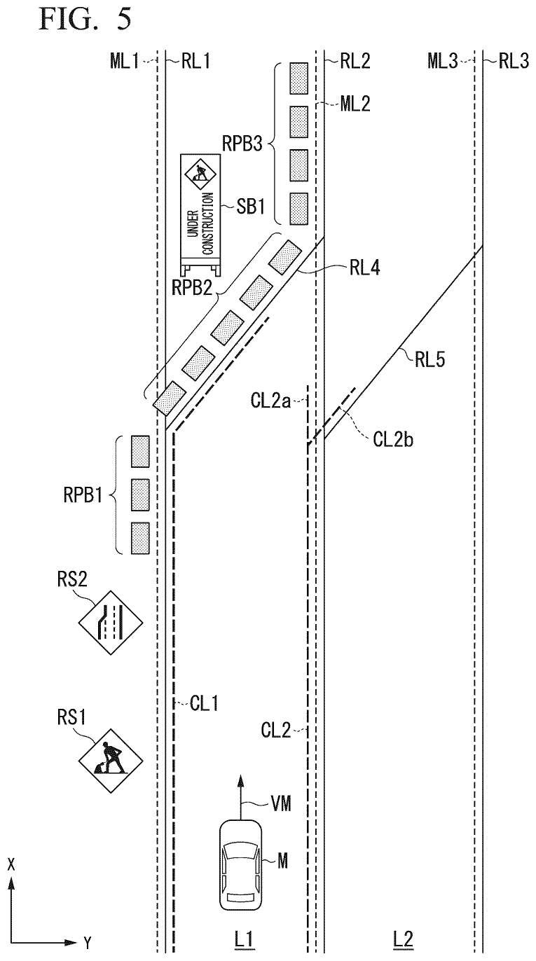

FIG. 5 is an explanatory view of judgment processing and driving control in a third scene. Compared to the second scene shown in FIG. 4, the example of FIG. 5 differs in that sign information indicating the presence of a construction site is present in the proceeding direction of the host vehicle M. Examples of sign information include a road sign RS, and a signboard SB. Therefore, hereinafter, description will focus on the foregoing difference.

For example, at a road construction site and the like, as shown in FIG. 5, road signs RS1 and RS2 and a signboard SB1 for notifying surrounding vehicles of the road information related to construction are installed at positions nearer than the construction site or in the vicinity of the construction site before the vehicle arrives at the construction site. In the third scene, the first recognizer 132 recognizes the road signs RS1 and RS2 and the signboard SB1 in addition to the camera demarcation lines CL and the road physical boundaries RPB. In this case, the first recognizer 132 may recognize specific contents of the road signs RS1 and RS2 and the signboard SB1 from feature information such as the shape, the pattern, character information, color information, and the like of the road signs RS1 and RS2 and the signboard SB1 included in the camera images and the like. The first recognizer 132 may recognize the distance to the construction site from the kinds and installation positions of the road signs RS1 and RS2 and the signboard SB1.

In the third scene, similarly to the second scene, when a plurality of camera demarcation lines on one side of the camera demarcation lines CL1 and CL2 on both the left and right sides of the traveling lane L1 of the host vehicle M are recognized by the first recognizer 132, the first one side camera demarcation lines included in the plurality of recognized one side camera demarcation lines and the map demarcation lines ML match each other, and predetermined conditions are satisfied (when the road physical boundaries RPB are present in the proceeding direction of the host vehicle M), the judger 142 reduces the reliability of the matching information of the first one side camera demarcation lines and the second demarcation lines which have matched each other. In this case, when it is estimated that the construction site is present within a predetermined distance in the proceeding direction of the host vehicle M on the basis of the recognition results of the road signs RS1 and RS2 and the signboard SB1 by the first recognizer 132, the execution controller 144 executes driving control of causing the host vehicle M to travel along the road physical boundaries RPB.

In this manner, according to the third scene, it is possible to more accurately ascertain the presence of a construction site by the sign information of the surrounding area. For this reason, when the road physical boundaries RPB are present in the proceeding direction of the host vehicle M and the sign information indicating a construction site is present, efficient driving control can be executed while giving priority to the road physical boundaries RPB by executing driving control based on the road physical boundaries RPB instead of the camera demarcation lines CL or the map demarcation lines ML.

### [Regarding Driving Control]

Here, driving control by the driving controller will be described. The execution controller 144 determines driving control with respect to the host vehicle M on the basis of the judgment results of the judger 142 and executes the determined driving control. For example, the expression “determining driving control” may include determining the details (kind) of driving control, and determining whether or not to execute (whether or not to curb) driving control. For example, the expression “executing driving control” may include continuing driving control which is already being executed, in addition to switching and executing the details of driving control. The expression “curbing driving control” may include not only not executing (terminating) driving control but also lowering the automation level of driving control. The driving control executed by the execution controller 144 may include the ACC, the TJP, the LKAS, the ALC, the CMBS, and the like. Furthermore, it may include various driving control to avoid contact with the surrounding vehicles. The execution controller 144 generates a target track for executing driving control and outputs the generated target track to the second controller 160.

Here, driving control executed by the execution controller 144 includes at least first driving control and second driving control. For example, the first driving control is driving control of controlling one of or both the steering and the speed of the host vehicle M on the basis of the demarcation lines recognized by the first recognizer 132 or the second recognizer 134 (for example, the demarcation lines where the camera demarcation lines and the map demarcation lines match each other). For example, the first driving control is driving control of causing the host vehicle M to travel such that the representative point in the host vehicle M passes through the center of the lane demarcated by the demarcation lines. For example, the second driving control is driving control of controlling one of or both the steering and the speed of the host vehicle M on the basis of the map demarcation lines or the traveling positional information of different vehicles. For example, the second driving control is driving control of causing the host vehicle M to travel such that the representative point in the host vehicle M travels over a track along the traveling trajectory of the different vehicle m1.

Moreover, may include driving control third driving control in which the camera demarcation lines are prioritized over the map demarcation lines and at least control of steering of the steering and the speed of the host vehicle M is executed, and fourth driving control in which the map demarcation lines are prioritized over the camera demarcation lines and at least control of steering of the steering and the speed of the host vehicle M is executed. For example, prioritizing the camera demarcation lines over the map demarcation lines denotes that processing based on the camera demarcation lines is performed basically but processing temporarily switches to processing based on the map demarcation lines, for example, when the accuracy of recognizing the camera demarcation lines falls below the threshold or the camera demarcation lines cannot be recognized any longer. Prioritizing the map demarcation lines over the camera demarcation lines denotes that processing based on the map demarcation lines is performed basically but processing temporarily switches to processing based on the camera demarcation lines, for example, when the map demarcation lines cannot be identified. For example, the third driving control and the fourth driving control are driving control performed when the camera demarcation lines and the map demarcation lines do not match each other (when the matching degree is smaller than the threshold).

Driving control may include a plurality of kinds of driving control based on automation levels (an example of degrees of automation). For example, the automation levels include a first level, a second level whose degree of automation in driving control is lower than that of the first level, and a third level whose degree of automation in driving control is lower than that of the second level. The automation levels may include a fourth level whose degree of automation in driving control is lower than that of the third level. Here, the automation levels may be levels determined by standardized information, regulations, or the like, or may be index values which are set independently from these. Therefore, the kinds, the details, and the numbers of the automation levels are not limited to the following examples. For example, a low degree of automation in driving control denotes that the rate of automation in driving control is small and tasks imposed on a driver are large (severe). Low automation in driving control denotes that the degree of controlling steering or acceleration/deceleration of the host vehicle M by the autonomous driving control device 100 is low (the degree of necessity of driver's intervention in operation of steering or acceleration/deceleration is high). Examples of the tasks imposed on a driver include monitoring surrounding areas of the host vehicle M and operation of the driving operation piece. Examples of operation of the driving operation piece include a state in which a driver is gripping the steering wheel (hereinafter, a hand-on state). Examples of the tasks imposed on a driver include a task on an occupant (driver's task) necessary to maintain autonomous driving of the host vehicle M. Therefore, when an occupant cannot execute the imposed task, the automation level is lowered. For example, the driving control in the first level may include driving control of the ACC, the ALC, the LKAS, and the TJP, for example. The driving control in the second or third level may include driving control of the ACC, the ALC, and the LKAS, for example. The driving control in the fourth level may include manual driving. During the driving control in the fourth level, driving control of the ACC and the like may be executed, for example. In the first to fourth levels, the first level has the highest degree of automation in driving control, and the fourth level has the lowest degree of automation in driving control.

In the first level, no tasks are imposed on an occupant (tasks imposed on a driver are the lightest). For example, the task imposed on an occupant in the second level is monitoring the surrounding areas (particularly, ahead) of the host vehicle M. For example, the task imposed on an occupant in the third level includes a hand-on state in addition to monitoring the surrounding areas of the host vehicle M. The task imposed on an occupant (for example, a driver) in the fourth level is operation for controlling the steering and the speed of the host vehicle M using the driving operation piece 80, in addition to monitoring the surrounding areas of the host vehicle M and a hand-on state, for example. Namely, in the case of the fourth level, the vehicle is in a state in which an occupant can immediately take over driving and the tasks imposed on a driver is the most severe. The details of driving control in each automation level and the tasks imposed on an occupant are not limited to the examples described above. The autonomous driving control device 100 executes driving control in any of the first to fourth levels on the basis of the surrounding situation of the host vehicle M or the task executed by an occupant. At least some of the first to fourth levels may be associated with the first to fourth driving control described above, for example.

For example, when the judger 142 judges that both the camera demarcation lines CL and the map demarcation lines ML are correct demarcation lines (for example, the camera demarcation lines CL and the map demarcation lines ML match each other), the execution controller 144 generates a target track for executing the first driving control. When one of the camera demarcation lines CL and the map demarcation lines ML is judged to be correct, a target track for executing driving control in any of the second to fourth levels is generated on the basis of the correct demarcation line. In addition, the execution controller 144 may perform control, such as terminating driving control with respect to the host vehicle M and switching to manual driving of an occupant, on the basis of the judgment results. Moreover, the execution controller 144 may switch the automation level corresponding to the driving control on the basis of the judgment results. In this case, for example, when the camera demarcation lines CL and the map demarcation lines ML are judged to be correct, driving control in the first level is executed, and when it is judged that they are not correct, driving control in the second to fourth levels is executed depending on the situation. The execution controller 144 generates a target track corresponding to each of the judgment results in the first to third scenes described above and executes driving control of the host vehicle M.

### [Processing Flow]

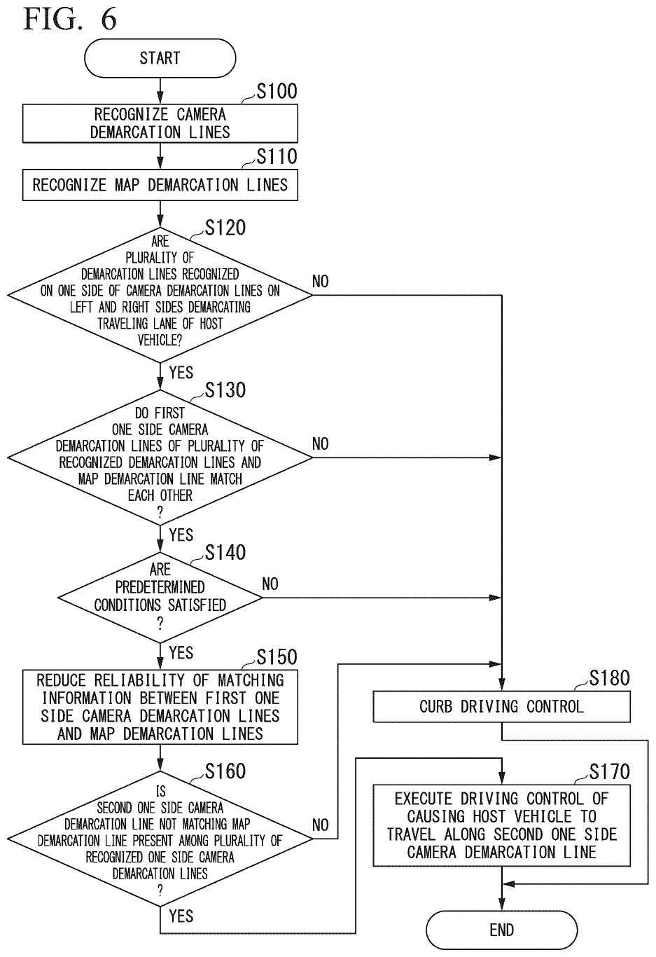

Hereinafter, processing executed by the autonomous driving control device 100 of the embodiment will be described. FIG. 6 is a flowchart showing an example of processing executed by the autonomous driving control device 100 of the embodiment. Hereinafter, regarding processing executed by the autonomous driving control device 100, description will mainly focus on driving control processing including processing of curbing misjudgment of the demarcation lines. The processing described below may be repeatedly executed at predetermined timing intervals or in a predetermined cycle and may be repeatedly executed while autonomous driving is executed by the autonomous driving control device 100.

In the example of FIG. 6, the first recognizer 132 recognizes the demarcation lines (camera demarcation lines) present around the host vehicle M (within a predetermined distance) on the basis of an output of the detection device DD which has detected the surrounding situation of the host vehicle M (Step S100). In the processing of Step S100, the first recognizer 132 may recognize different vehicles, road physical boundaries, sign information, obstacles, and the like present around the host vehicle. Next, the second recognizer 134 recognizes the demarcation lines (map demarcation lines) present around the host vehicle M from the map information with reference to the map information on the basis of the positional information of the host vehicle M (Step S110).

Next, the judger 142 judges whether or not a plurality of demarcation lines are recognized on one side of the camera demarcation lines on the left and right sides demarcating the traveling lane of the host vehicle M (Step S120). When it is judged that a plurality of demarcation lines are recognized, the judger 142 judges whether or not any of the one side camera demarcation lines (first one side camera demarcation lines) of the plurality of recognized demarcation lines and the map demarcation line match each other (Step S130). When it is judged that they match (for example, the matching degree is equal to or larger than the threshold), the judger 142 judges whether or not the predetermined conditions are satisfied (Step S140). When it is judged that the predetermined conditions are satisfied, the judger 142 reduces the reliability in matching between the first one side camera demarcation lines and the map demarcation lines (Step S150).

Next, the judger 142 judges whether or not any one side camera demarcation line (second one side camera demarcation line) which does not match the map demarcation line is present among a plurality of recognized one side camera demarcation lines (the matching degree is smaller than the threshold) (Step S160). When the second one side camera demarcation line is present, the execution controller 144 executes driving control of causing the host vehicle M to travel along the second one side camera demarcation line (Step S170). When it is judged in the processing of Step S120 that a plurality of one side camera demarcation lines have not been recognized, when it is judged in the processing of Step S130 that the plurality of one side camera demarcation lines and the map demarcation lines do not match each other, when it is judged in the processing of Step S140 that the predetermined conditions are not satisfied, and when it is judged in the processing of Step S160 that no second one side camera demarcation line is present, the execution controller 144 curbs driving control with respect to the host vehicle M (Step S180). Examples of curbing driving control include switching from the first driving control to the second to fourth driving control, terminating the first driving control, not executing driving control when driving control is not being executed, and lowering the automation level. Accordingly, this flowchart ends.

In the embodiment, it is judged whether or not the road physical boundary is present in the proceeding direction of the host vehicle M in place of the processing of Step S160 shown in FIG. 6, and when it is judged that the road physical boundary is present, driving control of causing the host vehicle M to travel along the road physical boundaries may be executed in place of the processing of Step S170.

### Modification Example

For example, in the embodiment described above, the judger 142 may judge the degree of deviation in place of judging the matching degree between the camera demarcation lines (or the traveling trajectories) and the map demarcation lines. For example, the degree of deviation is an index value increasing as the differences between the amounts of deviation, the deviation angles, and the amounts of change in curvature of the camera demarcation lines and the map demarcation lines increase. In addition, in the embodiment, even when a different vehicle is present around (ahead of) the host vehicle M, correctness judgment of the demarcation lines may be performed or a target track along which the host vehicle M will travel may be generated on the basis of the road physical boundaries and the sign information. In the embodiment, when at least three or more camera demarcation lines are recognized on one side, the judger 142 may perform matching judgment between each of the camera demarcation lines and the map demarcation lines. When the camera demarcation lines equal to or more than a predetermined number are recognized on one side, the judger 142 may determine that the recognition accuracy has deteriorated and not perform matching judgment.

According to the embodiment described above, the autonomous driving control device 100 (an example of a vehicle control device) includes the first recognizer 132 recognizing a surrounding situation including the camera demarcation line (an example of a first demarcation line) demarcating the traveling lane of the host vehicle M and a different vehicle present around the host vehicle on the basis of an output of the detection device DD which has detected the surrounding situation of the host vehicle M, the second recognizer 134 recognizing the map demarcation line (an example of a second demarcation line) demarcating the lane around the host vehicle from the map information on the basis of the positional information of the host vehicle M, and the judger 142 judging whether or not the first demarcation line and the second demarcation line match each other. When a plurality of camera demarcation lines on one side of the camera demarcation lines present on the left and right sides of the host vehicle M are recognized by the first recognizer 132, the first one side camera demarcation line included in the plurality of recognized one side camera demarcation lines and the map demarcation line match each other, and the predetermined conditions are satisfied, the judger 142 reduces the reliability of the matching information between the first one side camera demarcation lines and the map demarcation lines which have matched each other so that misjudgment with respect to the demarcation lines can be curbed on the basis of the surrounding situation of the host vehicle. Therefore, more appropriate driving control can be executed in accordance with the recognition results around the vehicle. According to the embodiment, the continuity of driving control can be further improved. Further, this will ultimately contribute to development of sustainable transportation systems.

According to the embodiment, even when the camera demarcation lines on one side and the map demarcation lines match each other, misjudgment can be curbed more accurately by performing correctness judgment of the demarcation lines on the basis of the traveling trajectories of different vehicles, road physical boundaries, and the like. According to the embodiment, when a construction site or the like is present in the proceeding direction, misjudgment can be curbed by performing the control described above, even under the road conditions in which demarcation lines and road shapes are likely to be misjudged, for example, the demarcation lines allowing vehicles to travel while avoiding a construction site are temporarily drawn, old demarcation lines before being changed due to construction still remain, and the demarcation lines have been redrawn. Therefore, driving control can be executed (continue) using more appropriate information.

The embodiment described above can be expressed as follows.

A driving control device includes a storage medium storing computer-readable instructions, and a processor connected to the storage medium. The processor executes the computer-readable instructions to: recognize a surrounding situation including a first demarcation line demarcating a traveling lane of a host vehicle and a different vehicle present around the host vehicle on the basis of an output of a detection device detecting the surrounding situation of the host vehicle, recognize a second demarcation line demarcating a lane around the host vehicle from map information on the basis of positional information of the host vehicle, and judge whether or not the first demarcation line and the second demarcation line match each other. When a plurality of first demarcation lines on one side of the first demarcation lines present on the left and right sides of the host vehicle are recognized, a first one side first demarcation line included in the plurality of recognized one side first demarcation lines and the second demarcation line match each other, and predetermined conditions are satisfied, a reliability of matching information between the first one side first demarcation line and the second demarcation line which have matched each other is reduced.

Hereinabove, forms for performing the present invention have been described using an embodiment. However, the present invention is not limited to such an embodiment in any way, and various modifications and replacements can be added thereto within a range not departing from the gist of the present invention.

What is claimed is:

1. A vehicle control device comprising:
a first recognizer recognizing a surrounding situation including a first demarcation line demarcating a traveling lane of a host vehicle and a different vehicle present around the host vehicle on the basis of an output of a detection device detecting the surrounding situation of the host vehicle;
a second recognizer recognizing a second demarcation line demarcating a lane around the host vehicle from map information on the basis of positional information of the host vehicle; and
a judger judging whether or not the first demarcation line and the second demarcation line match each other,
wherein when a plurality of first demarcation lines on one side of the first demarcation lines present on the left and right sides of the host vehicle are recognized by the first recognizer, a first one side first demarcation line included in the plurality of recognized one side first demarcation lines and the second demarcation line match each other, and predetermined conditions are satisfied, the judger reduces a reliability of matching information between the first one side first demarcation line and the second demarcation line which have matched each other.

2. The vehicle control device according to claim 1,
wherein the predetermined conditions include that the different vehicle passes over the first one side first demarcation line which has been judged to match the second demarcation line.

3. The vehicle control device according to claim 1 further comprising:
a driving controller executing driving control by controlling one of or both a steering and a speed of the host vehicle on the basis of judgment results of the judger,
wherein when a second one side first demarcation line which has been judged not to match the second demarcation line by the judger is present among the plurality of one side first demarcation lines recognized by the first recognizer, the driving controller controls traveling of the host vehicle on the basis of the second one side first demarcation line.

4. The vehicle control device according to claim 1,
wherein the predetermined conditions include that the host vehicle is traveling within a predetermined distance range nearer than a spot under construction or a spot where construction has been carried out in the past.

5. The vehicle control device according to claim 1,
wherein the predetermined conditions include that a road physical boundary is present in a proceeding direction of the host vehicle.

6. The vehicle control device according to claim 1 further comprising:
a driving controller executing driving control by controlling one of or both a steering and a speed of the host vehicle on the basis of judgment results of the judger,
wherein when a road physical boundary extending in a direction different from directions of the first one side first demarcation line and the second demarcation line which have matched each other is present, the driving controller causes the host vehicle to travel along the road physical boundary.

7. The vehicle control device according to claim 3,
wherein when the second one side first demarcation line extends along the road physical boundary, the judger judges that the second one side first demarcation line is a correct demarcation line, and
the driving controller causes the host vehicle to travel along the second one side first demarcation line.

8. The vehicle control device according to claim 7,
wherein the driving controller adjusts a position of the second one side first demarcation line in a direction in which the road physical boundary extends, and causes the host vehicle to travel along the adjusted position of the second one side first demarcation line.

9. The vehicle control device according to claim 8,
wherein when a distance between the road physical boundary and the second one side first demarcation line is shorter than a predetermined distance, the driving controller adjusts the position of the second one side first demarcation line.

10. The vehicle control device according to claim 6,
wherein when the host vehicle is traveling in a lane having a gradient equal to or larger than a predetermined value, the driving controller does not execute driving control based on the road physical boundary.

11. The vehicle control device according to claim 6,
wherein when sign information indicating a construction site is present in a proceeding direction of the host vehicle, the driving controller causes the host vehicle to travel along the road physical boundary.

12. A vehicle control method in which a computer recognizes a surrounding situation including a first demarcation line demarcating a traveling lane of a host vehicle and a different vehicle present around the host vehicle on the basis of an output of a detection device detecting the surrounding situation of the host vehicle,
recognizes a second demarcation line demarcating a lane around the host vehicle from map information on the basis of positional information of the host vehicle, and
judges whether or not the first demarcation line and the second demarcation line match each other,
wherein when a plurality of first demarcation lines on one side of the first demarcation lines present on the left and right sides of the host vehicle are recognized, a first one side first demarcation line included in the plurality of recognized one side first demarcation lines and the second demarcation line match each other, and predetermined conditions are satisfied, a reliability of matching information between the first one side first demarcation line and the second demarcation line which have matched each other is reduced.

13. A computer readable non-transitory storage medium storing a program for causing a computer to
recognize a surrounding situation including a first demarcation line demarcating a traveling lane of a host vehicle and a different vehicle present around the host vehicle on the basis of an output of a detection device detecting the surrounding situation of the host vehicle,
recognize a second demarcation line demarcating a lane around the host vehicle from map information on the basis of positional information of the host vehicle, and
judge whether or not the first demarcation line and the second demarcation line match each other,
wherein when a plurality of first demarcation lines on one side of the first demarcation lines present on the left and right sides of the host vehicle are recognized, a first one side first demarcation line included in the plurality of recognized one side first demarcation lines and the second demarcation line match each other, and predetermined conditions are satisfied, a reliability of matching information between the first one side first demarcation line and the second demarcation line which have matched each other is reduced.
